(19) United States
(12) Patent Application Publication
(10) Pub. No.: US 2026/0172394 A1
(43) Pub. Date: Jun. 18, 2026

(54) AUTOMATED FIREWALL TUNING

(71) Applicant: Akamai Technologies, Inc., Cambridge, MA (US)

(72) Inventors: Akul Dewan, Roswell, GA (US); Leonid Mirkis, Newton, MA (US)

(21) Appl. No.: 18/982,582

(22) Filed: Dec. 16, 2024

(51) Int. Cl. H04L 9/40

(52) U.S. Cl. CPC H04L 63/0263

(57) ABSTRACT

Systems and methods for improving a multi-tenant web firewall are disclosed. When network traffic violates a firewall rule, the firewall can communicate that event to an analyzer component. The analyzer checks the decision of the firewall by applying—to that same traffic—a machine learning model and/or a variety of additional rules. If the analyzer determines that the traffic is benign, meaning that the original decision was a false positive, then the analyzer triggers a rule generator that creates an exception to the firewall's ruleset, so as to allow such traffic going forward. The newly generated exception is sent for installation in the firewall. The analyzer and rule generation can be operated on a tenant by tenant basis, serving to improve each tenant's firewall ruleset independently of others.

### BACKGROUND

### Technical Field

This application generally relates to computer networking and to the operation and maintenance of network firewalls.

### Brief Description of the Related Art

A firewall applies a variety of rules (e.g., logical expressions) to inspect traffic for attempted attacks and other malicious or suspicious activity. In a multi-tenant firewall, each tenant has the ability to configure the firewall to filter traffic directed to its domains in a desired configuration, separate and independent of other tenants.

Today, many firewalls operate at the application layer, meaning inspect the application layer messages that are encapsulated in the lower network layer (this may be in addition to lower level inspection). A typical web application firewall examines HTTP messages going to and from a web server. The firewall rules look for known attack vectors, such as cross site scripting attack (XSS) or other OWASP defined top attacks.

An example of a multi-tenant, web application firewall is described in U.S. Pat. No. 8,458,769, titled “Cloud Based Firewall System And Service” and issued Jun. 4, 2013, the teachings of which are hereby incorporated by reference in their entirety.

Generally, a firewall is configured with a variety of rules, logical groups of which are sometimes referred to as a ruleset. A firewall configuration generally refers to this ruleset, and typically also includes mitigation actions to take when one of the rules is triggered. One problem with firewalls is that it is difficult to tune the rulesets to perfectly distinguish between good and bad traffic. A firewall might block traffic that is actually legitimate. This is referred to as a false positive. Firewall tenants are often worried about these false positives, because they mean that a legitimate user (e.g., which could be a customer on an e-commerce site) is perhaps being denied access. So users (that is, the firewall tenants) may decide to configure the firewall to merely alert on potential attacks, rather than block them, which undercuts the purpose and value of the firewall.

Tuning a firewall is today a manual, time-consuming process performed by security professionals. Using their expertise and experience, along with a set of heuristic rules that are designed to catch false positives or false negatives, the security professionals can detect poor-performing firewall rules and author better ones. But this approach is not practical for large-scale multi-tenant firewalls. Moreover, websites and web applications are always evolving. And bad actors are continually changing their attacks in an attempt to avoid detection. As a result, continual tuning of the firewall is usually necessary.

The teachings hereof describe, among other things, automated detection of false positives in multi-tenant firewalls, and the automated tuning of each tenant's configuration to address these false positives. The teachings hereof can be applied to other tuning goals too, such as automated tuning to address false negatives, or to identify situations where it is safe to deny traffic, that is, by upgrading a firewall's mitigation action from an “alert” to a “block”. Hence the technology disclosed herein improves the security and efficacy of firewall operation, thus improving the capability and efficiency of computer and network systems.

Those skilled in the art will understand these and other improvements from the teachings hereof.

### BRIEF DESCRIPTION OF THE DRAWINGS

The invention will be more fully understood from the following detailed description taken in conjunction with the accompanying drawings, in which:

FIG. 1 illustrates an automated firewall tuning system, in accordance with one embodiment of the teachings hereof;

FIG. 2A illustrates a multi-tenant firewall, as known in the prior art;

FIG. 2B illustrates the multi-tenant firewall shown in FIG. 2A, modified with the teachings hereof, in accordance with one embodiment of the teachings hereof; and,

FIG. 3 illustrates hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways. Any reference to advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms is assumed. All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtualized.

As mentioned earlier, a multi-tenant firewall provides a filtering service that each tenant may customize for their traffic. A given tenant configures the firewall with a set of rules (e.g., regexes, access control lists, and other forms of rules) that look for attack vectors in network traffic hitting the firewall. The multi-tenant firewall applies different rules to different slices of traffic (e.g., traffic within the tenant's domain, subdomain, or path) is mapped to an applicable set of rules. If the firewall detects a potentially malicious message, it can be configured to take a mitigating action such as blocking or rejecting the request.

The teachings hereof provide an automated process that generates tuning recommendations and indeed new rules to be installed in the firewall. The new rules may be additive or replace existing rules. Regardless, this process is referred to as automatically “tuning” the firewall. Note that firewalls can be operated at any network layer. While the description that follows focuses on tuning a firewall at the application layer, this is merely for ease of description.

To tune the firewall, a second check of traffic can be introduced. When network traffic violates a rule, or collection or rules, installed in the firewall, the firewall can send a notification to an out-of-band component, referred to here as a false-positive reduction component (FPR). The firewall's notification can indicate which rule (or rules) was violated and thus flagged the request as an attack, and which tenant and configuration they relate to. The notification can also include some or all of the client message that triggered the rule. (This is sometimes referred to as the contents of the rule's “selector”.) For example, a set of HTTP headers might be included, and/or path string, query string, or a cookie. In some implementations a portion of the HTTP body (if relevant to the rule violation), or a copy of the entire message might be included.

The FPR can input the offending message (or portion thereof) from the firewall's notification through a trained machine learning model, which is commonly referred to in the art as inferencing. The model produces a confidence score as to whether the message is truly an attack or benign. If benign (signaling a false positive), then the FPR initiates a process to create a new “allow” rule for the firewall. That process will be explained in further detail below.

Preferably, FPR and rule generation occurs on a tenant by tenant, or domain by domain basis, serving to improve each tenant's firewall performance independently of others. Put another way, each tenant's ruleset is improved and updated, independently of the others, based on the false positives generated by their ruleset as applied to their domain's traffic.

Typically, the newly created rule defines a specific exception to otherwise blocked or denied or alerted traffic. The characteristics of the message that resulted in the false positive can be captured in an “allow” rule that enables such traffic, or similar traffic, to pass through the firewall. The automated system may generate many of these exceptions. But in accord with the teachings hereof, many different but narrow “holes” in the firewall can be automatically created while the existing firewall rules for attack detection are maintained.

In a further embodiment, in addition to using the trained machine learning model, the FPR may input the captured message through another ruleset that is specifically designed for use in the FPR. This ruleset is sometimes referred to as an authoritative ruleset, because it is considered to override the initial determination of the ruleset installed in the firewall (sometimes referred to as a ‘ground truth’ ruleset. This ruleset can be the result of other intelligence feeds, including research into the expected use of the network endpoint that is being protected, and expected users thereof (so for example, if the endpoint is a web application, normal usage by users of that web application, or for a an endpoint that is an API, normal machine usage thereof).

Note that it is not required for the authoritative ruleset to comprehensively capture all benign traffic or all false positives. Rather, it should produce an accurate result when it classifies traffic as benign. In other words, if it indicates whether the traffic is a false positive, it does so with a high degree of confidence. That does not necessarily mean that it catches all false positives.

Note that the FPR preferably runs asynchronously and parallel to the network flow. In other words, the firewall has already made a decision about the message in its notification to the FPR. And the firewall has already taken whatever mitigating action is defined in its current configuration. Preferably, the FPR is not overriding that decision synchronously, but rather looking to improve the ruleset and firewall configuration for the future.

### System

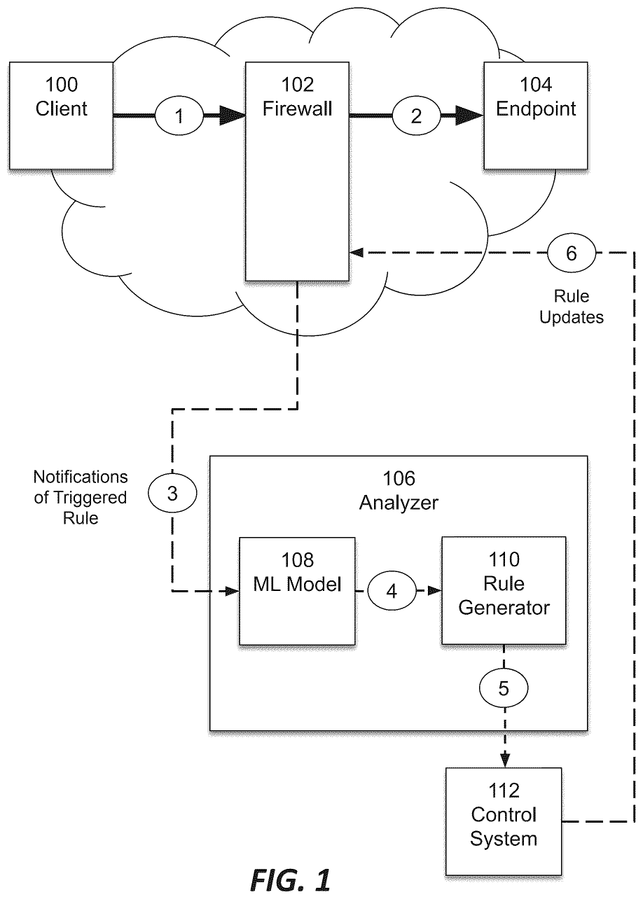

FIG. 1 is a diagram of an embodiment of firewall with automated tuning. A firewall 102 is logically positioned on the network path between a client 100 and an endpoint 104. An example of a client 100 is an end user device, or a network enabled process (sometimes referred to as machine traffic or bots). Examples of an endpoint 104 include a web application, API, or website. A client 100 is directed to the firewall 102 through any one of several known techniques, including BGP routing, Anycasting, DNS mapping, policy based routing (PBR), and the like.

Solid arrows 1 and 2 represent the flow of network traffic (e.g., Internet traffic). The dashed arrows, 3 to 6 represent the out of band communication channels which may be thought of as a control plane that can adjust the firewall's filtering capabilities. (A tenant of the firewall may use a web based portal or control center to configure the firewall 102 to their specifications through the control system 112; this component is known in the art and is not shown in FIG. 1.)

The firewall 102 thus monitors messages arriving over the network from the client 100 and possibly responses from the endpoint 104 back to the client. For simplicity of illustration, the following description will assume that the network messages being examined are the ones from the client 100.

When the firewall 102 detects that a rule matches on something in the client's traffic (at 1), the firewall 102 captures the relevant message (or messages) and sends a notification (at arrow 3) to the Analyzer) 106 component. As mentioned above, the notification can include:
1) an indication of the firewall rule that was violated
2) an identification of the firewall tenant (and applicable ruleset configuration)
3) an identification of the rule that was involved, which includes a selector for a particular portion of the message that the rule operates against
4) the client's network message or portion thereof that triggered the rule violation (e.g. a set of HTTP headers might be included, and/or path string, query string, or a cookie), sometimes referred to as the contents of the rule's selector
5) metadata about the client's network message, such as date/time, detected client geography, and the like

In sum, the Analyzer 106 is receiving a stream of firewall notifications about rules being triggered, as indicated by arrow 3.

The Analyzer 106 feeds extracts the client's messages form the firewall notifications and inputs them into the trained ML model 108 for inference. The model 108 produces an indication of whether the client's message is truly malicious. Typically this is expressed in the form of a confidence score. For example, the confidence that the client's message is benign may be expressed on a scale of 1 to 100. If the level of confidence exceeds a configured but adjustable threshold (e.g., 90), then the FPR 160 deems the message as benign and the firewall's 102 decision to be a false positive.

As mentioned, the FPR 160 can augment the decision of the ML model 108 with another check by an authoritative ruleset that reflects the latest security research and understanding about attacks and the operation of endpoints like endpoint 104. The output of this ruleset is likewise an indication of whether the client message is a false positive.

In practice, the Analyzer 106 can track such “false positives” over a period of time. The Analyzer 106 tracks the false positives in with the associated firewall rule that was erroneously triggered, and vector of characteristics of the client message, such as source IP address, application layer headers, client and/or firewall geography, time of day, URL requested, HTTP method, and the like. At the end of the time period, the Analyzer 106 examines the data to find frequent occurrences of a particular false positive, where frequent is defined by (for example) a threshold level (e.g., N times within the time period of T for a rule violation of type R). The Analyzer 106 may also be configured to look at the similarity of the hostname, client geo, URL, or other factors in deciding whether to aggregate or group together instances of false positives. In some implementations, the FPR 160 groups the records as they arrive, and keeps an aggregated count.

Here is a fictional example of tracked data for illustrative purposes:

TABLE 1

| | Firewall | | | | | |
|---|---|---|---|---|---|---|
| Time | Rule | | | | | |
| Period | Typecode | Source IP | URL path | . . . | Client Geo | Message Data |
| T | 1078 | 192.0.2.0 | /products/cart | . . . | US-Calif. | encoded-blob1 |
| T | 0045 | 192.32.2.48 | /about/xyz | . . . | France-Marseille | encoded-blob2 |
| T | 1078 | 192.0.2.24 | /products/checkout | . . . | US-Calif. | encoded-blob3 |
| T | 0803 | 192.0.2.2 | /login/redo | | US-NY. | encoded-blob4 |
| . . . | | | | | | |
| T + 1 | 0107 | 192.4.12.6 | foo/bar | . . . | Canada-QC | encoded-blob5 |

In the example above, lines 1 and 3 might be treated as the same and aggregated in the table. This proceeds and the aggregated count may increase as similar false positives are seen.

It should be understood that while FIG. 1 depicts just one firewall 102, in many embodiments there is a large distributed set of firewalls 102 handling network traffic. Hence, the notification stream 3 received by the Analyzer 106 can be from many different firewalls 102 distributed around the Internet. The tracking of analysis of the aggregated data can give the Analyzer 106 a view of false positives across many firewalls and indeed around the Internet, with respect to the monitored traffic for endpoint 104.

The result of the foregoing analysis is used by the Analyzer 106 to decide whether to initiate the rule generation process, which is performed by component 110 shown in FIG. 1. If so, the Analyzer 106 sends to the rule generator 110 the information from the firewall notifications at 3.

The Rule Generator 110 creates an exception (allow-rule) for the firewall 102, based on the client message(s) that caused the false positive. This allow-rule is sent to the control system 112, which is responsible for distributing it through control channels to the firewall 102. The control system 112 can include a dashboarding or UI component that enables a human operator to validate and/or confirm that the newly generated allow rule should be installed.

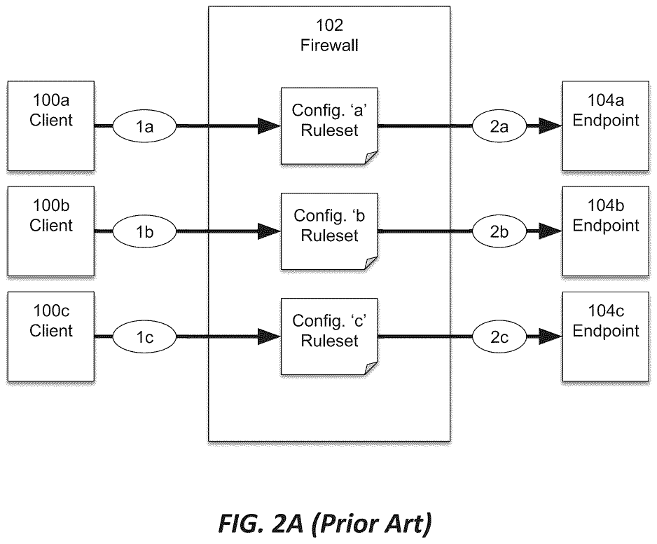

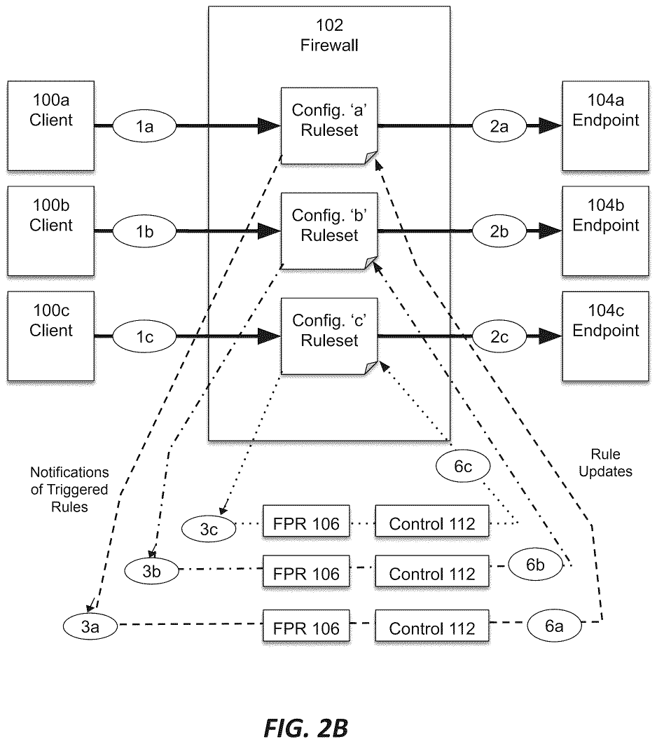

FIGS. 2A and 2B are diagrams of the system shown in FIG. 1 but with more detail to show how the system handles flows for different tenants of the multi-tenant firewall 102.

FIG. 2A illustrates a multi-tenant firewall as known in the art from e.g., U.S. Pat. No. 8,458,769. Assume that there are three different tenants of the system. As known in the art, each tenant is able to create their own configuration with the firewall rules that they want to use to protect their respective endpoint, and the actions to take when such firewall rules are triggered. These different configurations are installed in the firewall 102. When the firewall receives traffic from a client 100a-c, it determines which endpoint 104 that the client is attempting to reach. This may be done based on domain, for example. The firewall 102 then applies the appropriate rule configuration a, b, or c.

FIG. 2B illustrates how the multi-tenant firewall is enhanced with the automated tuning components and methods that were described earlier. Preferably, the tuning of the ruleset in each configuration a-c is performed independently of each other. Each tenant's client traffic (1a-c), configurations (a-c), and notifications (3a-c) are isolated from one another. Put another way, the stream of notifications from the firewall 102 in 3a is specific and distinct from those in 3b and 3c. Each stream 3a-c reflects the notifications the firewall 102 finds for the particular client traffic and configuration (including the ruleset) with which it is associated.

The Analyzer 106 can use the same trained ML model 102 to analyze the different notifications stream (3a-c), and the same Rule Generator 110 logic. However, the tracking of false positives is done separately for each tenant and their associated rule configurations. Hence the allow-rules that are created (and sent at 6a-c) are customized for each rule configuration. In this way, the system is able to independently tune each tenant's rule configuration based on the existing configuration the tenant has installed in the firewall 102, and the nature of the client traffic going to that tenant's endpoint 104.

### ML Model Details

The teachings hereof are not limited to any specific machine learning model. Various types of supervised/unsupervised approaches may be used, including regression modeling, decision trees, neural networks and unsupervised clustering.

In one embodiment, the ML model is trained on a sample set of HTTP requests received from end user clients 100 (e.g., at the firewall 102). An HTTP request often has multiple parts, including a set of headers, a cookie (a special type of header), and a body. Before training the set of HTTP requests is preprocessed. The HTTP requests are sanitized to remove, e.g., designated stop words, punctuations, and to remove query parameters or paths.

After sanitization, the HTTP request is re-formatted into one large string. The string is then converted into bigrams (meaning two adjacent word, or word pairs). The bigrams are converted to numbers using an encoding technique, such as word2vec, which is a known algorithm that vectorizes each bigram by the importance of the words within the bigram itself and their adjacent bigrams and locality of the bigrams. As a result, the large string is converted into a row of numbers.

Continuing with the example, principal component analysis (PCA) is used to reduce dimensionality of the row number, for example the size can be limited to 50. PCA is a known analytical technique that essentially removes redundant components (here, the redundant numbers), such that only independent numbers exist.

Finally, a model is trained with the row numbers. In this embodiment, the model is a collection of decision trees arranged so each tree can correct or adjust the output of the prior tree, which is known in the art and sometimes referred to as a last gradient boost model. The trained model is used as a classifier to predict whether a given input row is an attack or not.

### Rule Generator Details

As mentioned earlier, if the Analyzer 106 decides to create an allow rule, the Analyzer 106 sends to the rule generator 110 a copy of the information that the Analyzer 106 received in the firewall notifications (at 3 in FIG. 1). The rule generator 110 uses this information to construct an allow-rule.

For example, the input to the rule generator can be as follows:
a. the firewall tenant, e.g. a customer
b. the applicable ruleset or firewall configuration, e.g., ruleset 1234 for website example.com
c. the applicable firewall rule, e.g., a rule with a selector defining the aspect of the message that the rule operates against
d. the contents of the selector for the applicable firewall rule that were deemed to be a false positive

Given this information, the rule generator 110 looks at the contents of the selector for the triggered rule and creates an exception to the rule. The rule generator 110 creates a “do-not-inspect” instruction that will be associated with the specified ruleset and rule. The “do-not-inspect” instruction is a conditional statement that applies if certain conditions are met—namely, that the rule selector matches the contents of the selector. The instruction can be generated in the syntax and/or language of the firewall configuration (e.g., XML, etc).

For example, assume that a tenant's firewall rule (id=5) in ruleset (id=1234) checks the cookie name in an HTTP message for a SQL injection attack. The contents of the cookie name selector was “test-script-4” and this was determined to be a false positive by the Analyzer 106. Hence, the rule generator 110 produces an exception to the firewall in this situation: for this tenant, under ruleset 1234, do not inspect the cookie name for SQL injection (rule 5) when the cookie name is “test-script-4”.

As can be seen, the scope of the exception to the firewall protection is dictated by the scope of the rule and selector that was determined to be a false positive. There may be generated many such recommendations for exceptions (also referred to as allow-rules or do-not-inspect rules).

### Control System Details

The control system 112 may be any kind of system known in the art capable of distributing commands to the firewall 102 and other firewalls 102 distributed around the Internet. One example of a control channel is a so-called metadata channel, as described in U.S. Pat. No. 7,240,100, the teachings of which are hereby incorporated by reference. However the teachings hereof are not limited thereto.

While the examples given above have focused on the rule generator 110 creating a new “exception” for installation in the firewall, the firewall 102 can nevertheless still be configured such that, at least for an initial period after installation, the firewall will still alert on traffic meeting the exception. This precaution can be maintained for a probationary time period so that the results of the new rule on production traffic can be monitored before alerting is removed.

### Variants

While the examples given above have focused on the detection of false positives, the teachings of this patent document encompass a number of other variants and use cases. Examples are below.

Safe to Deny Traffic. The system can be modified to check traffic that is merely being alerted on (not blocked) at the firewall 102. In this case, the firewall 102 sends notifications at 3 about messages that triggered a firewall rule but the configured action/mitigation was only “alert”. The Analyzer 106 applies an ML model (and possibly additional heuristics) to determine that the traffic is truly malicious. Here, the Analyzer 106 bypasses the rule generation 110, and instead notifies the control system 112 at 5 to modify the mitigation action associated with the particular rule installed in the firewall 102 for the customer—namely, to change it from “alert” to “block.”

Platform Distributed Denial of Service (DDoS) Intelligence and Smart Fingerprints. This use case focuses on identifying clients 100 that are causing DDoS attacks. While it is known in the art to use IP-based reputation, that approach has downsides. According to this patent document, the system creates fingerprints of identity to find the malicious users. A fingerprint is a collection of identifiers, such as IP, TLS attributes, geo, user agent, date/time patterns, or others. This solution dynamically produces fingerprints that can be used to effectively block DDoS attackers.

ML-based Web Application Firewall. This technique adapts and evolves its attack detection techniques over time instead of the existing static rulesets. Here, the firewall 102 informs the Analyzer 106 on all traffic that is being passed through the firewall 102 (e.g., the notifications at step 3 of FIG. 1 include traffic that did not trigger any ruleset). This approach essentially looks for false negatives, with the rule generator 110 being tasked with creating a new rule to alert or block or otherwise mitigate some license of traffic that the ML model 108 has caught. The system sends the proposed rule to the control system 112, allowing the firewall 102 to be automatically tuned in a manner to block attacks it is missing, at step 6 in FIG. 1.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus-such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

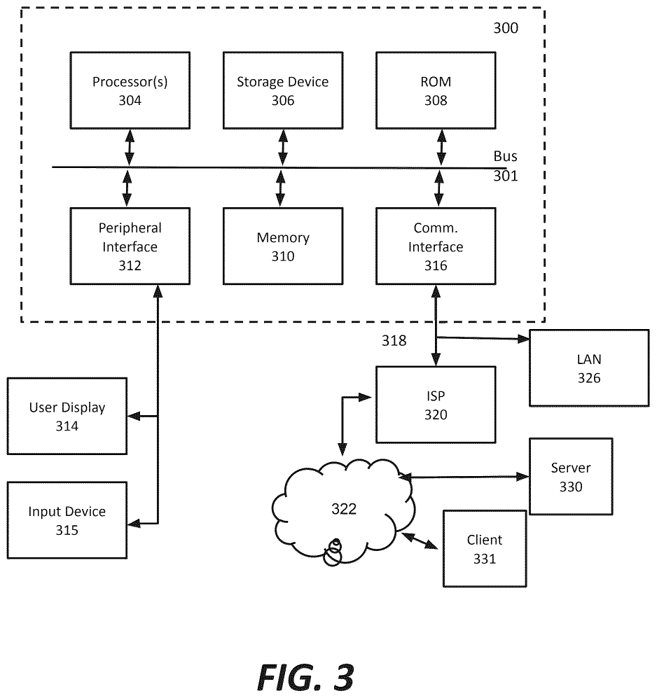

FIG. 3 is a block diagram that illustrates hardware in a computer system 300 upon which such software may run in order to implement embodiments of the invention. The computer system 300 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 300 includes a microprocessor 304 coupled to bus 301. In some systems, multiple processor and/or processor cores may be employed. Computer system 300 further includes a main memory 310, such as a random access memory (RAM) or other storage device, coupled to the bus 301 for storing information and instructions to be executed by processor 304. A read only memory (ROM) 308 is coupled to the bus 301 for storing information and instructions for processor 304. A non-volatile storage device 306, such as a magnetic disk, solid state memory (e.g., flash memory), or optical disk, is provided and coupled to bus 301 for storing information and instructions. Other application-specific integrated circuits (ASICs), field programmable gate arrays (FPGAs) or circuitry may be included in the computer system 300 to perform functions described herein.

A peripheral interface 312 may be provided to communicatively couple computer system 300 to a user display 314 that displays the output of software executing on the computer system, and an input device 315 (e.g., a keyboard, mouse, trackpad, touchscreen) that communicates user input and instructions to the computer system 300. However, in many embodiments, a computer system 300 may not have a user interface beyond a network port, e.g., in the case of a server in a rack. The peripheral interface 312 may include interface circuitry, control and/or level-shifting logic for local buses such as RS-485, Universal Serial Bus (USB), IEEE 1394, or other communication links.

Computer system 300 is coupled to a communication interface 316 that provides a link (e.g., at a physical layer, data link layer,) between the system bus 301 and an external communication link. The communication interface 316 provides a network link 318. The communication interface 316 may represent an Ethernet or other network interface card (NIC), a wireless interface, modem, an optical interface, or other kind of input/output interface.

Network link 318 provides data communication through one or more networks to other devices. Such devices include other computer systems that are part of a local area network (LAN) 326. Furthermore, the network link 318 provides a link, via an internet service provider (ISP) 320, to the Internet 322. In turn, the Internet 322 may provide a link to other computing systems such as a remote server 330 and/or a remote client 331. Network link 318 and such networks may transmit data using packet-switched, circuit-switched, or other data-transmission approaches.

In operation, the computer system 300 may implement the functionality described herein as a result of the processor executing code. Such code may be read from or stored on a non-transitory computer-readable medium, such as memory 310, ROM 308, or storage device 306. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 318 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method for automatically tuning a firewall to reduce false positives, the method comprising:
providing an firewall, the firewall providing a multi-tenant service where each tenant configures a respective set of firewall rules applicable to traffic falling within the respective tenant's domain;
receiving at the firewall a message sent over a network from a client, and associating the message with a particular tenant and a particular set of firewall rules;
determining that the message triggers at least one firewall rule of the particular set of firewall rules, causing the firewall to take a mitigation action against the message;
responsive to said determination, the firewall generating a notification that comprises at least a portion of the message;
based on the notification, inputting the at least a portion of the message into a trained machine learning model, which produces an indication that the message does not represent an actual attack (“false positive”);
over a period of time, tracking the false positives from the trained machine learning model for the particular set of firewall rules associated with the particular tenant, wherein false positives associated with other tenants and sets of firewall rules are tracked independently;
based on (i) the tracking of the false positives for the particular tenant and (ii) the at least a portion of the message, automatically generating a new firewall rule to allow the message; and,
sending the new firewall rule for installation in the firewall, wherein the installation is in the particular set of firewall rules for the particular tenant.

2. The method of claim 1, wherein the firewall comprises an application layer firewall and the message comprises an application layer message.

3. The method of claim 2, therein the application layer message comprises an HTTP message.

4. The method of claim 1, wherein the firewall protects a web application of the particular tenant with which the client communicates.

5. The method of claim 1, wherein said tracking of said indications of false positives comprises an aggregating step.

6. The method of claim 1, wherein the indication that the message does not represent an actual attack (“false positive”) comprises a confidence score.

7. The method of claim 1, wherein the same trained machine learning model is used for inputting messages received in notifications from a plurality of sets of firewall rules for multiple tenants.

8. The method of claim 1, wherein the step of automatically generating the new firewall rule comprises:
identifying a plurality of elements of the message included in the notification sent by the firewall;
applying a filtering step based on a predefined configuration that specifies elements to remove from the plurality of elements; and,
creating an allow rule that looks for all of the identified but not filtered elements in subsequent messages.

9. The method of claim 8, wherein the plurality of elements comprises at least one of: header, structured data parameter, URL encoded body parameter, URL encoded query string parameter.

10. A network security system with a firewall that is automatically tuned, comprising:
a firewall that provides a multi-tenant service where each tenant configures a respective set of firewall rules applicable to traffic falling within the respective tenant's domain;
the firewall operable to:
receive a message sent over a network from a client, and associate the message with a particular tenant and particular set of firewall rules;
determine that the message triggers at least one firewall rule of the particular set of firewall rules, causing the firewall to take a mitigation action against the message;
responsive to said determination, generate a notification that comprises at least a portion of the message;
an analyzer that, based on the notification, operates to send the at least a portion of the message into a trained machine learning model, which produces an indication that the message does not represent an actual attack (“false positive”);
the analyzer operable to:
over a period of time, track the false positives from the trained machine learning model for the particular set of firewall rules associated with the particular tenant, wherein false positives associated with other tenants and sets of firewall rules are tracked independently;
based on (i) the tracking of the false positives for the particular tenant and (ii) the at least a portion of the message, automatically generate a new firewall rule to allow the message; and,
send the new firewall rule for installation in the firewall, wherein the installation is in the particular set of firewall rules for the particular tenant.

11. A non-transitory computer readable medium holding computer program instructions for execution on at least one hardware processor to cause at least one computer to perform steps comprising:
providing an firewall, the firewall providing a multi-tenant service where each tenant configures a respective set of firewall rules applicable to traffic falling within the respective tenant's domain;
receiving at the firewall a message sent over a network from a client, and associating the message with a particular tenant and particular set of firewall rules;
determining that the message triggers at least one firewall rule of the particular set of firewall rules, causing the firewall to take a mitigation action against the message;
responsive to said determination, the firewall generating a notification that comprises at least a portion of the message;
based on the notification, inputting the at least a portion of the message into a trained machine learning model, which produces an indication that the message does not represent an actual attack (“false positive”);
over a period of time, tracking the false positives from the trained machine learning model for the particular set of firewall rules associated with the particular tenant, wherein false positives associated with other tenants and sets of firewall rules are tracked independently;
based on (i) the tracking of the false positives for the particular tenant and (ii) the at least a portion of the message, automatically generating a new firewall rule to allow the message; and,
sending the new firewall rule for installation in the firewall, wherein the installation is in the particular set of firewall rules for the particular tenant.

12. A method for automatically tuning a firewall to block traffic that is safe to be denied, the method comprising:
providing an firewall, the firewall providing a multi-tenant service where each tenant configures a respective set of firewall rules applicable to traffic falling within the respective tenant's domain;
receiving at the firewall a message sent over a network from a client, and associating the message with a particular tenant and particular set of firewall rules;
determining that the message triggers at least one firewall rule of the particular set of firewall rules, causing the firewall to take a mitigation action which is to issue an alert on the message, whereas the firewall could have been configured to block the message;
responsive to said determination, the firewall generating a notification that comprises at least a portion of the message;
based on the notification, inputting the at least a portion of the message into a trained machine learning model, which produces an indication that the message does represent an actual attack;
over a period of time, tracking the indications from the trained machine learning model for the particular set of firewall rules associated with the particular tenant, wherein indications associated with other tenants and sets of firewall rules are tracked independently;
based on (i) the tracking of the indications for the particular tenant and (ii) the at least a portion of the message, automatically generating an instruction to change the mitigation action from alert to block; and,
sending the instruction for installation in the firewall, wherein the installation is in the particular set of firewall rules for the particular tenant.

13. The method of claim 12, wherein the firewall comprises an application layer firewall and the message comprises an application layer message.

14. The method of claim 13, therein the application layer message comprises an HTTP message.

15. The method of claim 12, wherein the firewall protects a web application of the particular tenant with which the client communicates.

16. The method of claim 12, wherein said tracking of said indications comprises an aggregating step.

17. The method of claim 12, wherein the indication that the message does represent an actual attack comprises a confidence score.

18. The method of claim 12, wherein the same trained machine learning model is used for inputting messages received in notifications from a plurality of sets of firewall rules for multiple tenants.
